(19) United States
(12) Patent Application Publication
(10) Pub. No.: US 2012/0066424 A1
(43) Pub. Date: Mar. 15, 2012

(54) PORTABLE COMPUTER FEATURING INTERCHANGEABLE SCREENS WITH DIFFERENT SIZES

(75) Inventor: GREGOIRE GENTIL, SAN FRANCISCO, CA (US)

(73) Assignee: ALWAYS INNOVATING, INC., SAN FRANCISCO, CA (US)

(21) Appl. No.: 12/880,455

(22) Filed: Sep. 13, 2010

(51) Int. Cl. G06F 13/00

(52) U.S. Cl. 710/303

(57) ABSTRACT

A laptop or notebook computer which features a detachable bottom keyboard part, that hosts the computation system, and features small connecting tips its the top end. Can be docked into this bottom keyboard part any screen with any size, as long as it features tip holes able to fit the connecting tips of the bottom keyboard part. Any screen of this kind a can be hot-plugged or unplugged, at any time, and instantly displays the standard video output of the system when docked into the bottom keyboard part. Any screen of this kind may also be fastened to the top screen part thanks to a quick-release locking system.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### FIELD OF THE INVENTION

The present invention is in the technical field of electronics. More particularly, the present invention is in the technical field of light portable computers.

### BACKGROUND OF THE INVENTION

The following description includes information that may be useful in understanding the present invention. It is not an admission that any of the information provided herein as prior art or relevant to the presently claimed invention, or that any publication specifically or implicitly referenced is prior art.

Notebooks, laptops, netbooks have existed for a long time. Their development has mostly been driven by an increased ease of carriage, a greater battery lifetime, and limited performances. Although major technical innovations have come out for these devices since they have been on the market, there has been much less innovations on the form factor.

In particular, they usually all feature a central unit that can do the computation, a screen, a battery system, and a human input system that consists of a keyboard and a touch pad. The screen is usually attached to the keyboard, cannot be separated from it, and closes on top of the keyboard. Although this general form factor is suitable for many uses, daily use of these devices show that the screen size could be reduced in many occasions, especially for ease of carriage purposes.

### SUMMARY OF THE INVENTION

The present invention is composed of an electronic device that has a bottom keyboard part, and one or several top screen parts. All these parts can be separated the one from the other, and only one top screen part at a time can be docked into the bottom keyboard part. When a top screen part is attached into the bottom keyboard part, the two parts are electronically connected the one with the other, making the whole system a notebook as described in the “Background of the invention”. Each top screen part has a different screen size, allowing one to choose the best size at any time, these screens being fully interchangeable and plugged or unplugged while the system is on.

The bottom keyboard part hosts the whole computation system, the battery, as well as some external connectors. It has a keyboard as well as a touch pad, used as standard human inputs for the computer.

Each top screen part hosts one screen. When detached from the bottom keyboard part, each top screen part cannot display anything and is not linked in any way to it. When attached to the bottom keyboard part, a top screen part is electronically linked to the bottom keyboard, and then displays the standard video output of the system, automatically adapted to the chosen screen size.

### BRIEF DESCRIPTION OF THE DRAWINGS

FIG. 1A is a perspective view of the bottom keyboard part and a full size top screen part, describing how to plug the one into the other to form a notebook.

FIG. 1B is a perspective view of the bottom keyboard part and a big size top screen part, describing how to plug the one into the other to form a notebook.

FIG. 1C is a perspective view of the bottom keyboard part and a small size top screen part, describing how to plug the one into the other to form a notebook.

FIG. 2A is a perspective view of the full size top screen part docked into the bottom keyboard unit, forming a notebook.

FIG. 2B is a perspective view of the big size top screen part docked into the bottom keyboard unit, forming a notebook.

FIG. 2C is a perspective view of the small size top screen part docked into the bottom keyboard unit, forming a notebook.

### DETAILED DESCRIPTION OF THE INVENTION

All references cited herein are incorporated by reference in their entirety as though fully set forth. Unless defined otherwise, technical and scientific terms used herein have the same meanings as commonly understood by one of ordinary skill in the art to which this invention belongs. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The present invention relates to electronic devices enable one to more easily perform usual computer tasks thanks to smart form factors.

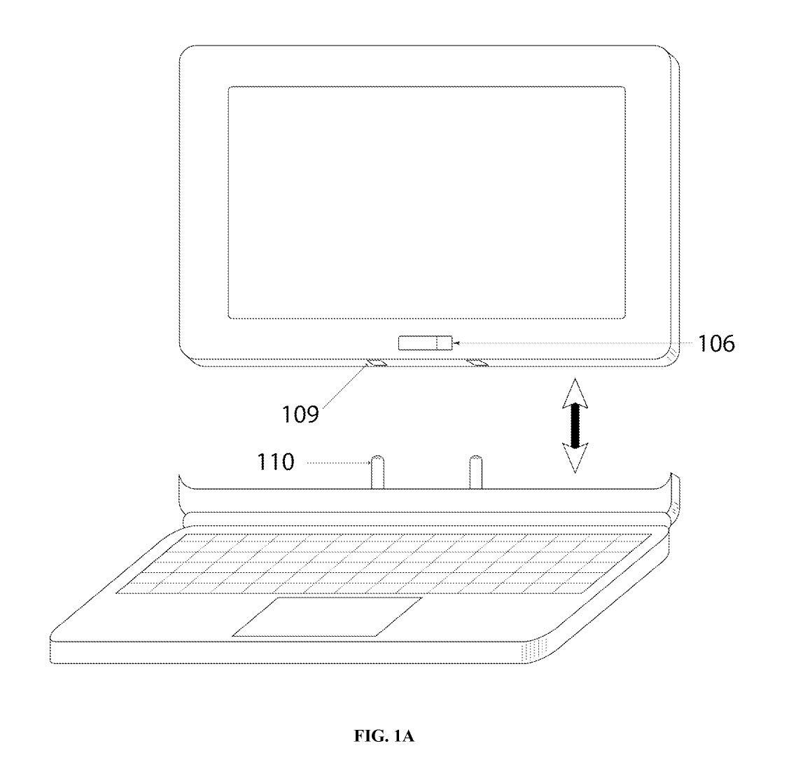

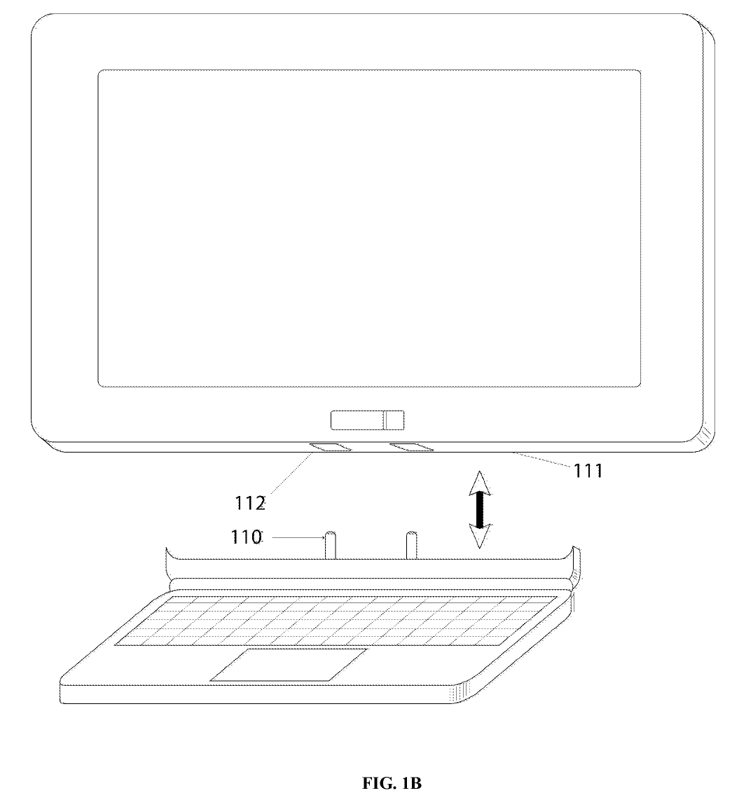

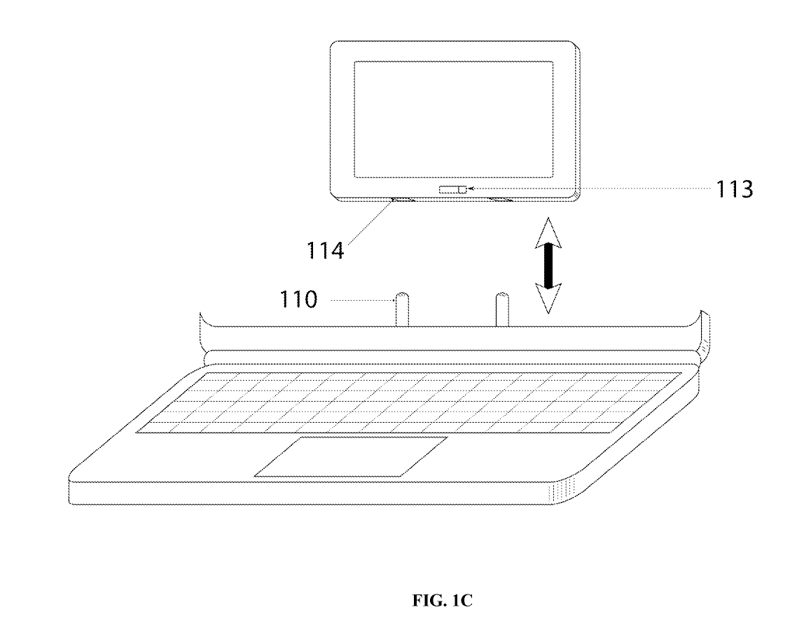

Referring now to the invention in more detail, in FIG. 1A are shown a full size top screen part 107 connected to the keyboard bottom part 101. Full size here means that the width of the top screen part 107 is very close or the same as the width of the keyboard bottom part 101. The top screen part 107 features a screen 108, as well as a battery.

The bottom keyboard part 101 hosts the whole computation system inside the case, and features a keyboard 103 and a touchpad 102, that can be used as input methods to the system. A hinge 104 allows the top screen part 107 to rotate around the bottom keyboard part 101 and close on top of it. The bottom keyboard part 101 can communicate electronically with the top screen part 107 thanks to connecting tips 110.

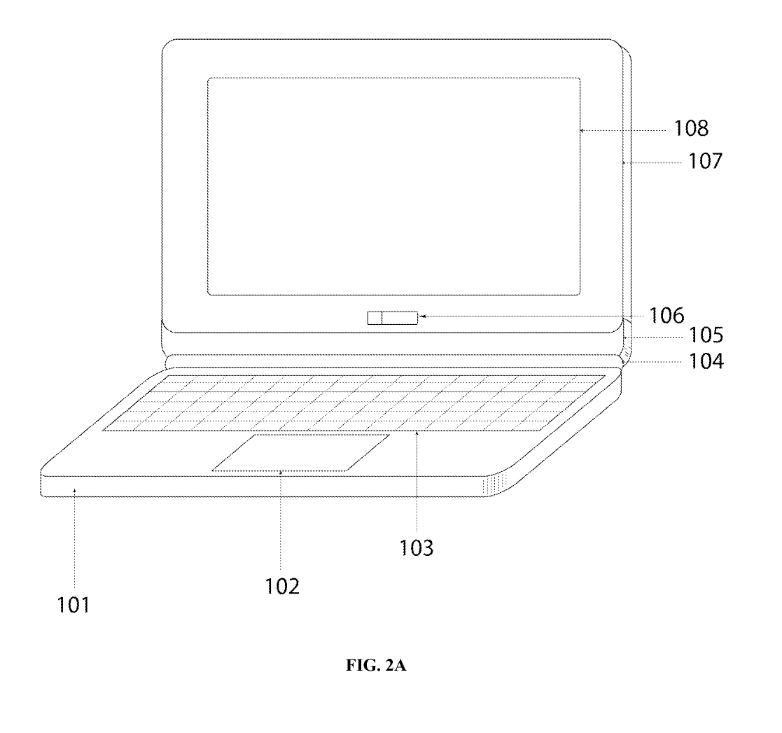

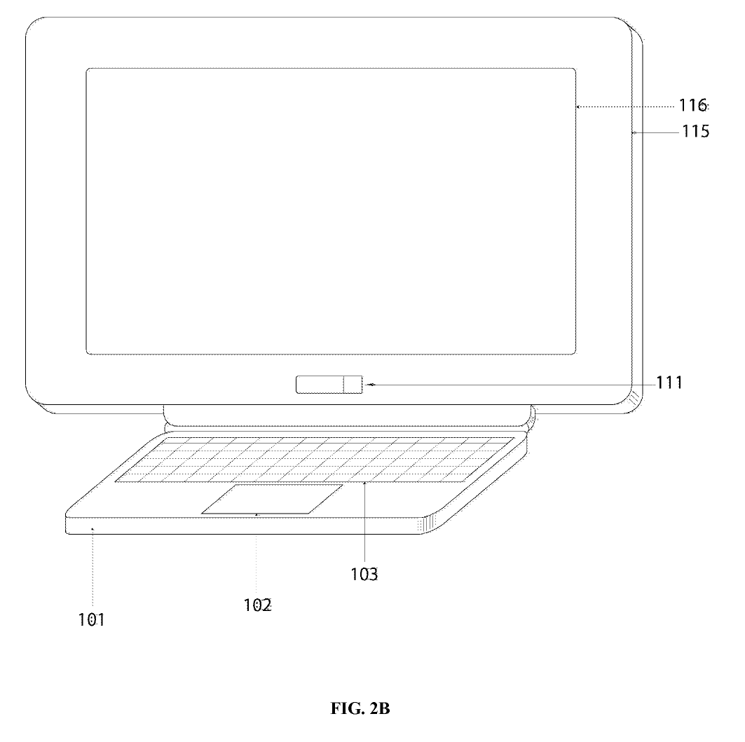

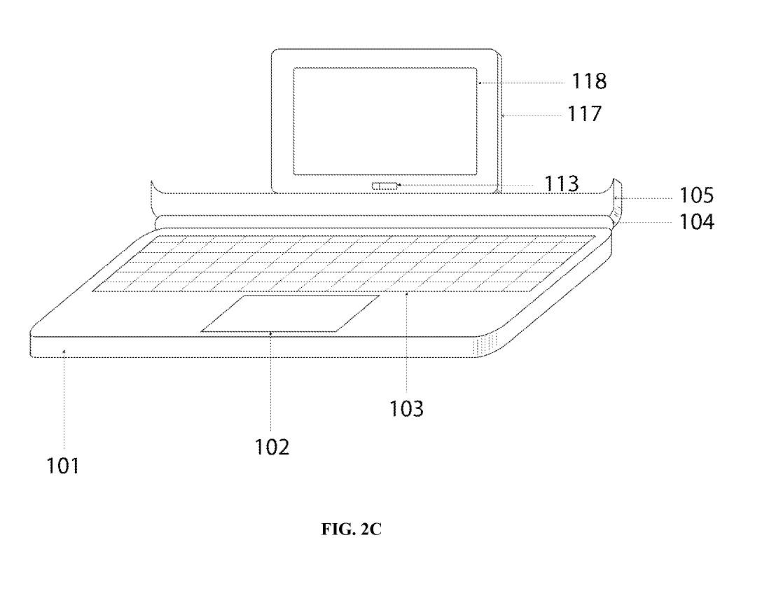

The top screen part 107 features a screen 108, as well as connecting tip holes 109. When attached the one to the other, as shown on FIG. 2a, the top screen part 107 and the bottom keyboard 101 part are electronically linked thanks to the connecting tips 110. That way, the top screen part 107 receives video input from the bottom keyboard part 101 and is used as a standard display. When the top screen part 107 is not connected to the bottom keyboard part 101, it is not electronically linked to it in any way. The top screen part 107 can be plugged and unplugged at any time from the bottom keyboard part 101 with no concerns.

As shown on FIG. 2B and FIG. 2C, the top screen parts 115 and 117 can also be docked one at a time into the bottom keyboard part 101. The top screen part 115 features a big size screen 116, as well as tip holes 112, allowing it to be plugged in and electronically linked to the bottom keyboard 101 when docked, as shown on FIG. 1B. Similarly, the top screen part 117 features a small size screen 118, and can as well be plugged in and electronically linked to the bottom keyboard 101 thanks to the tip holes 114, as shown on FIG. 1C.

The invention allows one to use any top screen part that features well-placed tip holes on one of its edges, whereby it can be docked into the bottom keyboard part 101. Any of these top screen part can be replaced by another one at any time, in particular while the system is on.

The top screen unit 107, or any other compatible top screen unit described above, can be securely attached to the additional unit 101 thanks to a locking system consisting of a lock button 106, that securely fasten the connecting tips 110 mounted on the screen receptacle 105, into the tip holes 109. Once locked, the top screen part 107 cannot be detached from the bottom keyboard 101, unless the locking system is released thanks to the lock button 106. For the purpose of the example, the locking system is working the same way on the top screen part 115 with the locking button 111, and on the top screen part 117 with the top screen part 113.

I claim:

1. A notebook computer, comprising:
a screen, said screen having a top edge, a bottom edge, a pair of side edges, and tip holes on any of those edges;
a computer keyboard, hosting the computation system, said keyboard having a top end;
a screen receptacle, said screen receptacle having a top edge, a bottom edge, a pair of side edges, and tips on the top edge that are sized to fit into the said tip holes of the said screen;
hinges for pivotally attaching the bottom edge of said screen receptacle to the top end of said keyboard;
whereas the said tips of the said screen receptacle can be connected into any tip hole on any edge of the said screen;
whereas said screen can have any size, and especially can have a different width than said screen receptacle.

2. The notebook computer as recited in claim 1, further including quick-release locks positioned on any edge or face of said screen, whereby said screen and said screen receptacle may be fastened together.

3. The notebook computer as recited in claim 1, wherein the connecting tips provide power to the screen.

4. The notebook computer as recited in claim 1, wherein the connecting tips provide video data to the screen.

5. The notebook computer as recited in claim 1, wherein the screen comprises an additional touch screen layer.

6. The notebook computer as recited in claim 1, wherein the connecting tips are HDMI connectors.

7. The notebook computer as recited in claim 1, wherein the top edge of the screen receptacle is magnetic.

8. The notebook computer as recited in claim 7, wherein the bottom edge of the screen is in a material able to hold magnetic materials.

9. The notebook computer as recited in claim 1, wherein the bottom edge of the screen is magnetic.

10. The notebook computer as recited in claim 9, wherein the top edge of the screen receptacle is in a material able to hold magnetic materials.
